(19) United States
(12) Patent Application Publication
(10) Pub. No.: US 2008/0177539 A1
(43) Pub. Date: Jul. 24, 2008

(54) METHOD OF PROCESSING VOICE SIGNALS

(75) Inventors: Tai-Huei Huang, Yunlin County (TW); Po-Kai Huang, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/856,057

(22) Filed: Sep. 16, 2007

(30) Foreign Application Priority Data
Jan. 23, 2007 (TW) 96102443

(51) Int. Cl. G10L 17/00

(52) U.S. Cl. 704/246; 704/E17.004

(57) ABSTRACT

A method of processing voice signals suitable for enhancing the speech discrimination ability of a hearing impaired person is disclosed. First, a voice signal is received, and the received voice signal is divided into a plurality of voice frames. A frequency spectrum analysis is conducted on one of the voice frames to estimate the effective bandwidth of the voice frame. Next, a frequency transposition process is performed on the voice signal so as to suit the auditory sensation bandwidth of a hearing impaired person. In addition, an energy compensation process is performed on the voice frame after performing the frequency transposition process so as to compensate the reduced energy brought by the frequency transposition process.

### CROSS-REFERENCE TO RELATED APPLICATION

This application claims the priority benefit of Taiwan application serial no. 96102443, filed Jan. 23, 2007. All disclosure of the Taiwan application is incorporated herein by reference.

### BACKGROUND OF THE INVENTION

1. Field of the Invention

The present invention generally relates to a method of processing voice signals, and more particularly, to a method enhancing the speech discriminative ability of the hearing impaired people.

2. Description of Related Art

As the human life getting longer in the modern society, more and more seniors suffer from the verbal communication hardship because of the downgraded hearing. Usually, a hearing impaired person would use a hearing aid to enhance the hearing thereof. The basic principle of conventional hearing aid is to boost the energy level of the received voice signal according to the audiogram of the user so as to compensate the hearing loss thereof. In addition, the dynamic range of spectral fluctuation of the processed voice signal has to be compressed simultaneously to avoid producing an over amplification which may discomfort or damage the auditory nerves. The goal of hearing loss compensation can be achieved by the spectral gains which are parameterized by the auditory thresholds, a rising time and a falling time constants.

In addition, according to clinical investigations, the hearing problem caused by aging often starts from the auditory loss of high-frequency signal. FIG. 1A is an intensity distribution scope of daily sound over frequency. In FIG. 1A, the block 101 represents the intensity distribution scope of the voice signal with basic sounds measured at human's ear over frequency, the block 102 represents the intensity distribution scope of the voice signal with consonant (for example, letters b, c, f, etc.) over frequency and the block 103 represents the intensity distribution scope of the voice signal with vowel (for example, phonetic symbols [i], [a:], etc.) over frequency. FIG. 1B is an audiogram of an aging-caused hearing impairment, in which the curve 105 illustrates a hearing threshold of the hearing impaired. The spectral component with intensity lower than the threshold will not be perceivable by the person. It can be seen from FIG. 1B that the major hearing-loss frequency range for the hearing impaired person is high-frequency signals represented by the scope 104, in which the spectral components with frequency over 2 KHz can not be perceived by the person in normal situation. In this case, even performing the gain compensation process on the high frequency of the voice signal will not improve the speech discriminative ability of the person. Thus, how to enhance the speech discriminative ability of the hearing impaired whose audible bandwidth gets narrower than a normal person is a critical issue today.

With the advance of digital signal processing technique, a frequency transposition processing scheme is proposed to map the spectra of the received voice signal into the residual hearing bandwidth of a user, so as to overcome the problem that the audible bandwidth thereof gets narrower. FIG. 2 is a flowchart of a conventional process of frequency transposition. Referring to FIG. 2, a Discrete Fourier Transform (DFT) process is performed on a digitized voice signal A[n] (step S201). After the frequency analyzing, a frequency mapping function is used to compress and transpose the frequencies of the voice signal into a lower frequency band (step S202). After that, a Inverse Discrete Fourier Transform (IDFT) is performed on the compressed spectrum to obtain a voice waveform in the time domain (step S203). The details relating to the algorithm of the frequency transposition can refer to “Discrimination of Speech Processed by Low-Pass Filtering and Pitch-Invariant Frequency Lowering” (J. Acoust. Soc. Am. 74 (2) p.409˜419, 1983) and “Frequency Lowering Using a Discrete Exponential Transform” (EUROSPEECH’ 99, 2769-2772. 1999), respectively.

In addition, “Frequency Lowering Processing for Listeners with Significant Hearing Loss” (Proceeding of ICECS” 99. vol. 2, p741˜744, 1999) further proposed a scheme to increase the spectral peaks of the voice signal as well as the frequency transposition to enhance the voice recognition ability of the hearing impaired. In the above-mentioned theses, the frequency transposition is characterized by the sample rate and the auditory bandwidth of the user. In other words, the conventional frequency transposition is developed based on the assumption that the bandwidth of received voice signal is fixed and which is equal to the half sample rate. However, the assumption is not always true for some situations. For example, the effective bandwidth of the voice signal received from a far distance may become narrow due to the energy decay of the high frequency components of the voice signal. In addition, different voice types or different pronunciation characteristics wherein the voice bandwidths thereof are definitely varied. When the bandwidth of the received signal is smaller than the pre-defined one obviously, using the fixed frequency mapping function to process the narrow-banded signal will smear the spectral shape of the received voice signal. As a consequence, the recognizable effect of a voice with the above-mentioned processing is lowered.

In US Patent Publication No. 20040175010 “Method for Frequency Transposition in a Hearing Device and a Hearing Device”, another scheme was proposed, wherein a frequency transposition function was used to analogously imitate the sensitivity distribution of the human auditory nerves over the frequencies. The major definition parameters of the transposition function are the sample rate and the auditory bandwidth of the hearing impaired, but the processing is unable to adapt to the bandwidth varying of the received voice signal dynamically.

### SUMMARY OF THE INVENTION

Accordingly, the present invention provides a method of processing a voice signal. First, the effective bandwidth of one of voice frames of the voice signal is estimated, wherein the effective bandwidth is defined as a part of spectrum of the voice frame where the main energy of the voice signal is concentrated. Using the frequency mapping function that changes with the effective bandwidth, it is able to output a transformed signal that mostly preserves the spectral prominences and acoustics features thereof because it can prevent from an over compression on a narrow-banded voice signal. Next, the voice bandwidth is compressed and transposed into a low-frequency range in order to fit the auditory sensation bandwidth for the hearing impaired person and thereby to enhance the audibility and speech discriminability thereof. Furthermore, the energy reduction caused by transposing the high band into the lower band is compensated to retain the total energy of the original signal.

The present invention provides a method of processing voice signals. First, the bandwidth of a voice signal is estimated so as to determine the spectral transposition function before processing the received voice signal. Next, the transposition function for compressing and transposing the full band signal into a lower band is dynamically adjusted based on the estimated value of effective bandwidth so as to avoid the voice signal with a narrower bandwidth from a greater spectrum shape distortion which would be caused after compressing and transposing and affect the audibility and speech discriminability of a hearing impaired person. In addition, the energy reduction caused by transposing the higher band into the lower band is compensated to retain the total energy of the original signal.

The present invention provides a method of processing voice signals suitable for enhancing audibility and speech discriminability. The method of processing voice signals includes receiving a voice signal, wherein the voice signal is divided into a plurality of voice frames according to a window function. Next, one of the voice frames is converted from the time domain to the frequency domain, and the effective bandwidth of the voice frame is estimated. Next, a frequency transposition function is dynamically adjusted according to the amount of the effective bandwidth, and the adjusted frequency transposition function is further used to perform a frequency transposition process on the voice frame.

The present invention further provides a method of processing voice signals suitable for enhancing the audibility and speech discriminability of a hearing impaired person. The method of processing voice signals includes receiving a voice signal, wherein the voice signal is divided into a plurality of voice frames according to a window function. Next, it is judged whether one of the voice frames of the voice signal is a consonant containing higher energy of the high-frequency portion. When the voice frame is judged as a consonant featuring high-frequency voice, the effective bandwidth of the voice frame is estimated, and then a frequency transposition function is adopted to perform a frequency transposition process on the voice frame, wherein the frequency transposition function would be dynamically adjusted based on the amount of the effective bandwidth.

Since the present invention adopts a novel scheme of dynamically adapted mapping function of frequency transposition for the input voice signal so that the bandwidth with concentrated energy can be fully utilized during a frequency compression and transposition processing on the voice frame, therefore the original spectral feature is able to be preserved better than the prior art to enhance the audibility and speech discriminability of a hearing impaired person. Besides, the present invention would dynamically adjust the transposition function for compressing and transposing the input signal into the lower band based on the effective bandwidth of the voice frame, which enables a hearing impaired person to effectively percept a frequency spectrum variation of a voice originally belonging to the higher band. Furthermore, another process adopted by the present invention is to compensate the energy reduction caused by transposing the higher band to the lower band with, which allows maintaining the energy of the original signal.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is an intensity distribution scope of daily voice over frequency.

FIG. 1B is an audiogram of an aging-caused hearing impairment.

FIG. 2 is a flowchart of a conventional process of frequency transposition.

FIG. 3 is a flowchart of a method of processing voice signals according to an embodiment of the present invention.

FIG. 4 is a diagram where a voice signal is divided into a plurality of voice frames.

FIG. 5 is a diagram showing the calculation of an effective bandwidth.

FIG. 6 is a schematic graph showing how different dynamic adjustment parameters affect the frequency transposition function.

FIG. 7A is a diagram of an estimated effective bandwidth according to an embodiment of the present invention.

FIG. 7B is a diagram showing a frequency transposition process according to an embodiment of the present invention.

FIG. 7C is a diagram showing an energy compensation process according to an embodiment of the present invention.

FIG. 8 is a flowchart of a method of processing voice signals according to another embodiment of the present invention.

FIG. 9 is a calculation diagram of the energies of the lower band and the higher band for a high-frequency consonant.

FIG. 10A is a spectral graph of a voice signal without processing a frequency transposition.

FIG. 10B is a spectral graph of a voice signal after processing a conventional frequency transposition.

FIG. 10C is a spectral graph of a voice signal after processing a frequency transposition according to the embodiment of the present invention.

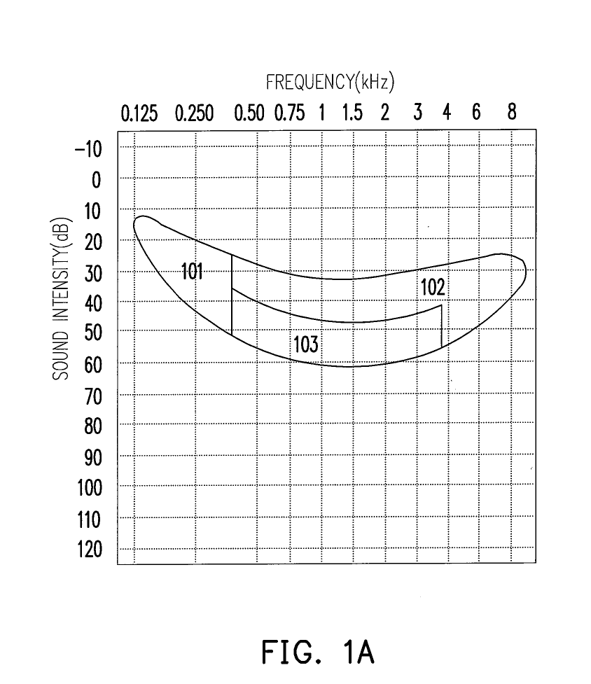

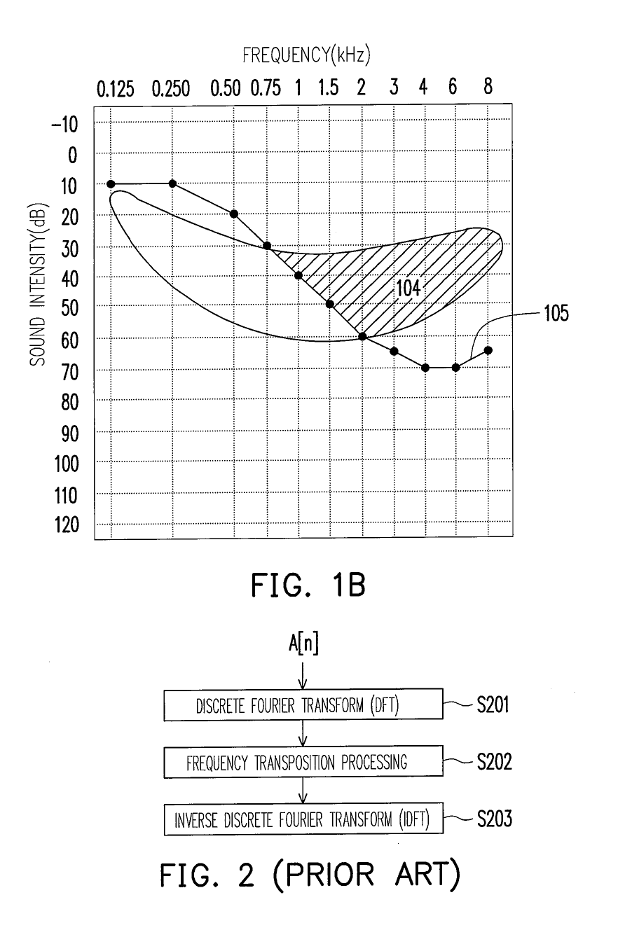

### DESCRIPTION OF THE EMBODIMENTS

Prior to explaining the embodiment of the present invention, it is temporally assumed the present embodiment is applied in a hearing aid for enhancing the audibility and speech discriminability of the hearing impaired person. However, the embodiment is not limited to the domain of the above-mentioned application. In fact, the present invention can be applied in other applications, for example, in a voice converter.

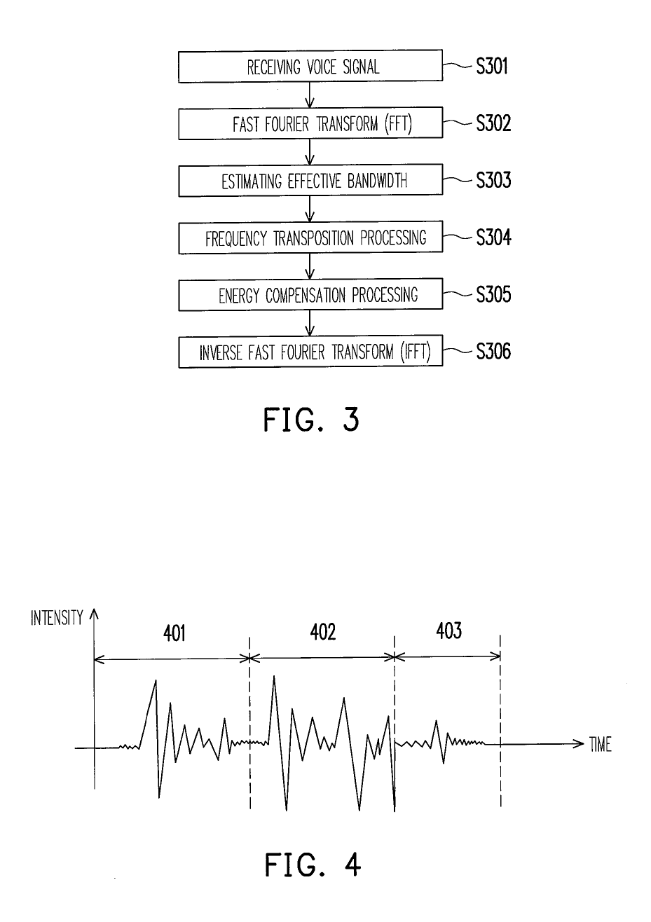

FIG. 3 is a flowchart of a method of processing voice signals according to an embodiment of the present invention. Referring to FIG. 3, first, a voice signal is received and the received voice signal is divided into a plurality of voice frames by using a window function, for example, a rectangular window function (S301). As shown by FIG. 4, 401, 402 and 403 represent different voice frames (only three successive voice frames are given herein). Next, a Fast Fourier Transform (FFT) is performed on one of the voice frames (step S302) and the frequency spectrum characteristic of the voice frame is analyzed in the frequency domain, wherein the voice signal is sampled and quantized prior to the FFT process.

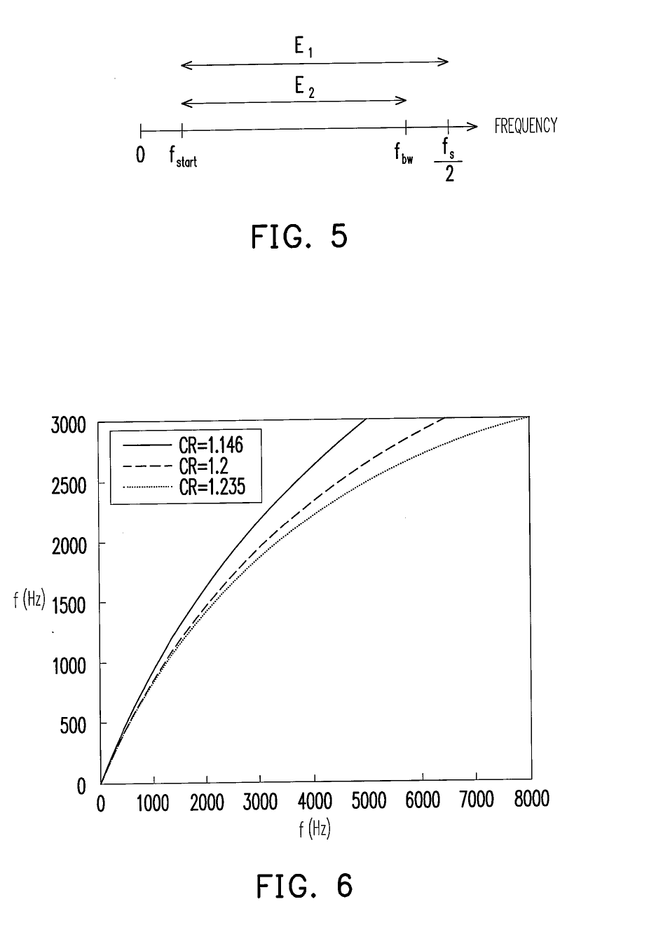

Next, the effective bandwidth of the voice frame is estimated (step S303). FIG. 5 is a diagram showing the calculation of the effective bandwidth. Referring to FIG. 5, a general energy E₁ spanning from a frequency of fₛₜₐᵣₜ to a frequency of fₛ/2 of the voice frame and an energy E₂ of a preset bandwidth spanning from fₛₜₐᵣₜ to f_{bw} of the voice frame are calculated, wherein fₛ is the sampling frequency of the voice signal, and fₛₜₐᵣₜ and f_{bw} respectively represent the lower frequency and the upper frequency of the preset bandwidth. Since the most frequency components of a human voice are lower than 8000 Hz; thus, it is reasonably assumed that the energy spanning from 800 Hz to 8000 Hz is the general energy E₁. When the ratio of the preset bandwidth E₂ over the total energy E₁ is a preset value, the effective bandwidth of the voice frame can be estimated as 0-f_{bw} Hz. For example, if the preset value is 0.9, the bandwidth sharing 90% of the total energy is estimated as the effective bandwidth.

After that, the effective bandwidth obtained from the voice frame is adjusted to the band perceivable by a hearing impaired person; i.e. a frequency compression and transposition processing is performed on the signal of the voice frame so as to transpose the effective bandwidth into a lower band (step S304), which benefits a hearing impaired person with a narrower auditory sensation bandwidth to perceive voice. The frequency compression and transposition processing uses a frequency transposition function to transpose the voice signal into the lower band. For example, the frequency transposition function f′=F(f)=1000 \sqrt{2} tan(arctan(f/(1000 \sqrt{2}))/CR), wherein f is the frequency prior to compressing and transposing, f′ is the frequency after compressing and transposing. CR is the dynamic adjustment parameter generated by an algorithm based on the estimated effective bandwidth, which CR can be expressed as CR=arctan(f_{bw}/(1000 \sqrt{2}))/arctan(fₕ/(1000 \sqrt{2})), wherein f_{bw} is the estimated effective bandwidth and fₕ is the bandwidth perceivable by a hearing impaired person. It can be seen that the frequency transposition function is dynamically adjusted based on the effective bandwidth of the voice frame, so that a proper frequency transposition process preserving the spectral prominence of the voice frame can be obtained.

The dynamic adjustment parameter is intended mainly for avoiding a voice signal with a narrower bandwidth from a greater frequency spectrum shape error generated by a compression and transposition processing if a fixed frequency transposition is performed on. It is obvious that a greater shape error would reduce the recognition effect of a voice signal after compression and transposition. FIG. 6 is a schematic graph showing how different dynamic adjustment parameters affect the frequency transposition function. Referring to FIG. 6, assuming the bandwidth fₕ perceivable by a hearing impaired person and the bandwidth of input signal f prior to compression and transposition are fixed (for example, f=8000 Hz), the less the estimated effective bandwidth f_{bw}, the less the dynamic adjustment parameter CR is and the greater the frequency number obtained from the effective bandwidth after the compression and transposition is. Thus, thanks to the dynamic adjustment parameter CR, the need of performing an extreme compression and transposition on a voice signal with a narrower bandwidth can be effectively avoided. Accordingly, a distortion of spectral shape can be reduced as well.

It is noted that the above-mentioned frequency transposition function is taken to an example in the embodiment of the present invention, but the present invention is not limited in that. Any person ordinarily skilled in the art can apply the effective bandwidth f_{bw} to other frequency transposition functions according to the teaching of the embodiment for dynamically adjusting those frequency transposition functions. Another embodiment of the present invention is taken to an example for guiding the person ordinarily skilled in the art to easily put the present invention into practice. The frequency transposition function is assumed to be fₒᵤₜ=F(fᵢₙ)=fₛ/K π tan⁻¹ [A×tan(πfᵢₙ/fₛ)], wherein fᵢₙ is the frequency prior to compressing and transposing, fₒᵤₜ is the frequency after compressing and transposing, and parameter A being a fixed constant is used for adjusting the curve ratio of the frequency transposition function F(fᵢₙ). The parameter K=fₛ/2f_{bw}, wherein f_{bw} is the estimated effective bandwidth, and fₛ is the sampling frequency of the voice signal. As the same with the description mentioned above, the frequency transposition function F(fᵢₙ) can be dynamically adjusted according the amount of the estimated effective bandwidth.

After processing a frequency transposition, since the effective bandwidth of the voice frame is compressed and transposed into the lower band, the voice energy would be reduced. In order to maintain the energy unaltered, the energy of the frequency transposed voice frame is compensated (step S305). To compensate the reduced energy, for example, the energy values of the voice frame and of the frequency transposed one thereof are respectively calculated and the ratio of the energy prior to the processing over the energy after the frequency transposition is defined as a gain value. Then, the spectrum of the voice frame after processing a frequency transposition is multiplied by the gain value so as to complete an energy compensation process. For example, a gain value G is expressed by:

$$G = \sqrt{{\sum }_{k = 1}^{N} {X}^{2} ( k , 1 )} / \sqrt{{\sum }_{k = 1}^{N} {X}^{′2} ( k , 1 )} ,$$

wherein X(k,1) and X′(k,1) respectively represent the amplitudes of the k-th spectral components of the l-th voice frame prior to and after processing a frequency transposition. The amplitude of spectrum X̅ (k,1)=G×X′(k,1), where 1≦k≦N and N represents the frequency bin number of the voice frame, i.e. the spectral component number after a FFT process.

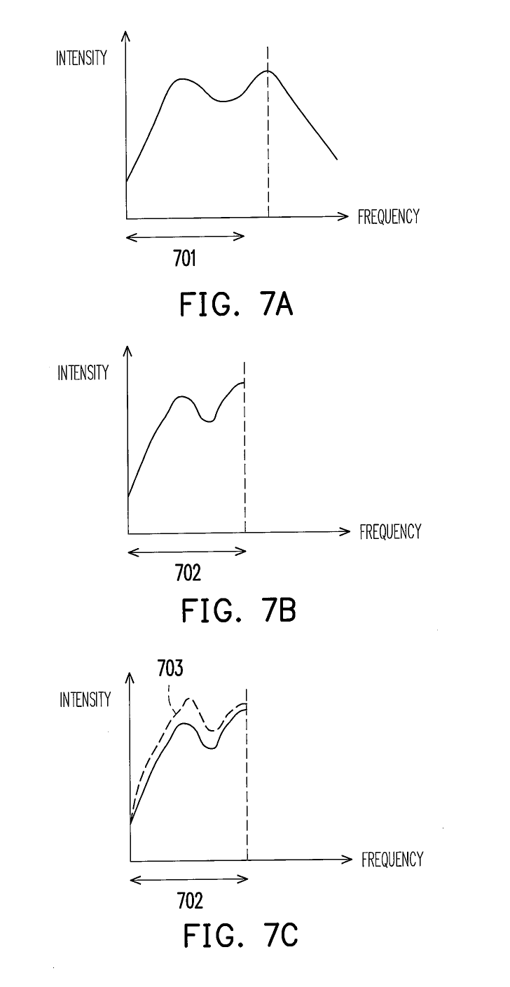

Furthermore, the spectrum of the voice frame is performed with an Inverse Fast Fourier Transform (IFFT) so as to convert it back to a signal waveform in the time domain (step S306). Thus, a voice signal may be adjusted to the band perceivable by a hearing impaired person. FIGS. 7A, 7B and 7C are diagrams used for describing the method of processing voice signals according to a preferred embodiment of the present invention. Referring to FIGS. 7A, 7B and 7C, first, the effective bandwidth of one of the voice frame of the voice signal is estimated, wherein a bandwidth 701 with concentrated energy as shown by FIG. 7A is selected as the effective bandwidth. Next, a frequency transposition process is performed on the effective bandwidth 701, as shown by FIG. 7B, so as to compress and transpose the effective bandwidth into a bandwidth 702 perceivable by a hearing impaired person. After that, an energy compensation process is performed on the effective bandwidth after processing the frequency transposition. The curve 703 in FIG. 7C illustrates the spectrum after the energy compensation process.

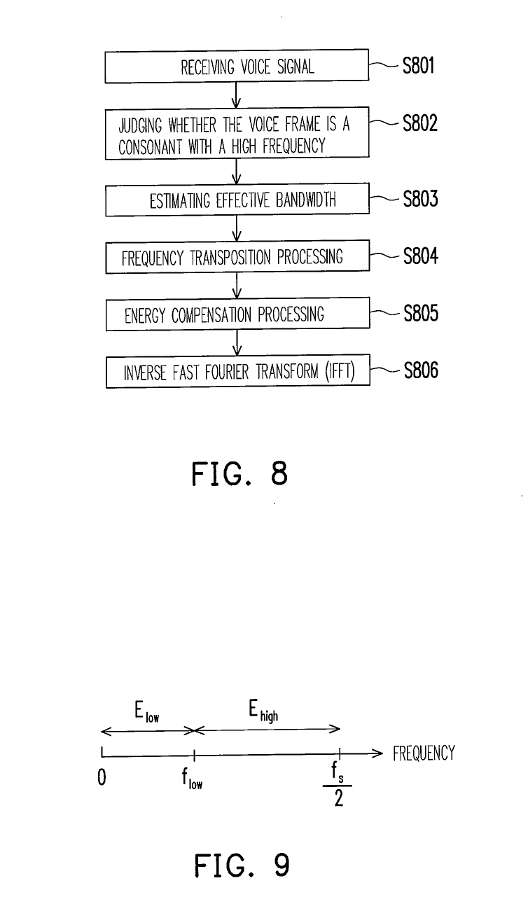

In another embodiment of the present invention, the method of processing voice signals is used to enhance the audibility and speech discriminability of a consonant featuring high-frequency voice. FIG. 8 is a flowchart of a method of processing voice signals according to another embodiment of the present invention. Referring to FIG. 8, first, a voice signal is received, wherein the voice signal is divided into a plurality of voice frames according to a window function, for example, a rectangular window function (step S801). Since the most phenomenon of impaired hearing caused by aging occurs with losing a perception on high-frequency signals; therefore, in order to enhance the recognition ability on a consonant featuring high-frequency voice, it is judged that whether one of the voice frame of the voice signal is a consonant featuring high-frequency voice (step S802), followed by performing a frequency transposition process on the bandwidth of the consonant featuring high-frequency voice, so that a hearing impaired person is able to recognize the consonants featuring high-frequency voice with a limited auditory bandwidth.

In the following, an example is given to describe how to judge the voice frame is a consonant featuring high-frequency voice. FIG. 9 is a calculation diagram of the energies of the lower band and the higher band for a high-frequency consonant. Referring to FIG. 9, the energy E_{low} of the lower band between 0 Hz and the frequency f_{low} of the voice frame and the energy E_{high} of the higher band between the frequency f_{low} and the frequency fₛ/2 are calculated, followed by calculating the energy ratio of the above-mentioned two energies. When the energy ratio is less than a preset parameter value, the voice frame is judged as a consonant featuring high-frequency voice. Next, a frequency transposition process and an energy compensation process are performed on the consonant featuring high-frequency voice frame. The steps are similar to the steps described with reference to FIG. 3, and therefore detailed description thereof is omitted for simplicity.

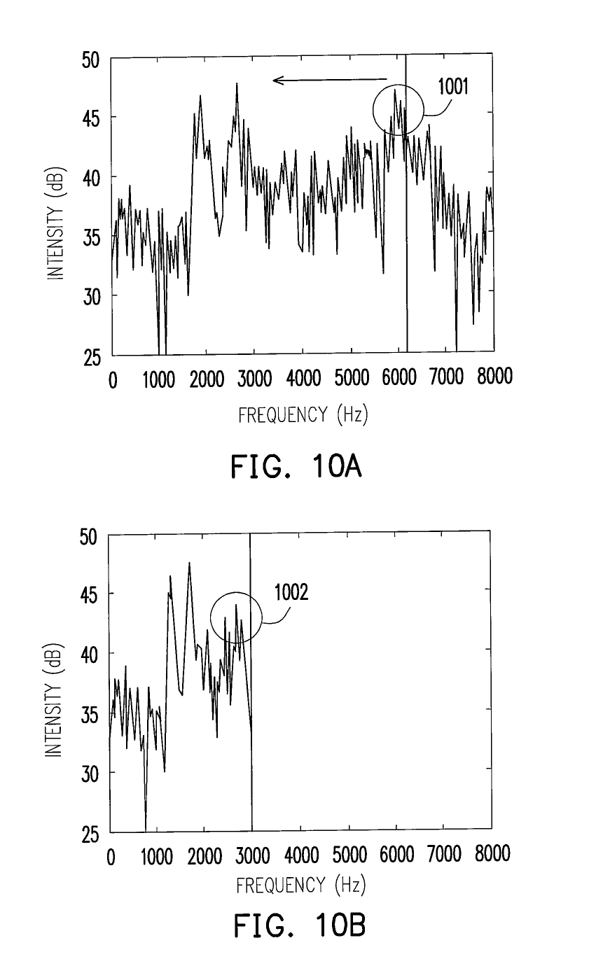

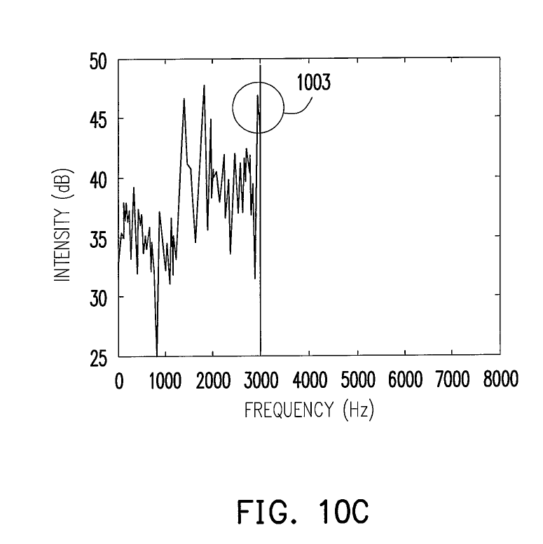

To compare the present embodiment with the prior art, a simulation test was conducted. FIGS. 10A, 10B and 10C are given to show the simulation test result. FIG. 10A is a spectral graph of a voice signal without processing a frequency transposition, FIG. 10B is a spectral graph of a voice signal after processing a conventional frequency transposition and FIG. 10C is a spectral graph of a voice signal after processing a frequency transposition according to the embodiment of the present invention. An predetermined portion 1001 selected from the spectral curve in FIG. 10A still preserve the peak of the original spectral components after processing a frequency transposition, as shown by the portion 1003 in FIG. 10C; while after processing a fixed frequency transposition function according to the prior art, the portion 1001 is converted into the portion 1002 as shown by FIG. 10B where an obvious distortion of lowered spectral peak can be found.

In order to prove the effect of the present embodiment for enhancing the recognition ability on a consonant featuring high-frequency voice, an experiment was carried out. A voice data including Chinese consonants featuring high-frequency voice, such as the Chinese syllables j, q, x, zh, ch, sh, z, c, s, h, is recorded. The recorded voice data is provided by four males and four females, which represents the recorded voice data is provided by different types of speakers. After that, three different processing methods are performed on the voice data, wherein in the first method, no frequency transposition process was conducted; the second method included performing a conventional process with a fixed frequency transposition function; the third method included performing a process with a dynamically adjusted frequency transposition function according to the embodiment of the present invention. The sampling frequency of a voice signal for the experiment is 16,000 Hz.

Assuming the auditory sensation bandwidth of a hearing impaired person is 2,000 Hz, therefore, a low-pass processing with 2,000 Hz bandwidth was conducted on all the voice data after the above-mentioned three processing so as to simulate the auditory sensation condition of a hearing impaired person. Next, 15 participants with normal hearing took test. The following table 1 lists out the average correctness rates of voice recognition.

TABLE 1
Average Correctness Rates of Voice Recognition

| Method | Average Correctness Rate (%) |
|---|---|
| Method 1 | 55.3% |
| Method 2 | 83.0% |
| Method 3 | 87.7% |

In summary, the present invention provides a method of processing voice signals, wherein the effective bandwidth of the voice frame of the voice signal with energy concentration is estimated. Next, a frequency transposition function is dynamically adjusted according to the amount of the effective bandwidth, so as to fully utilize the bandwidth with energy concentration and in the meantime preserve the features of the original frequency spectrum shape during a frequency transposition process on the voice signal, which further contributes to reduce a distortion after processing the frequency transposition. In addition, the method of processing voice signals provided by the present invention is able to compensate the reduced energy after processing a frequency transposition, and furthermore to enhance the voice recognition ability on a consonant featuring high-frequency voice.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of processing voice signals, suitable for enhancing voice recognition ability of a person, comprising:
receiving a voice signal, wherein the voice signal is divided into a plurality of voice frames according to a window function;
converting one of the voice frames into the frequency domain, and estimating an effective bandwidth of the voice frame; and
computing a frequency transposition function according to an amount of the effective bandwidth and performing a frequency transposition process on the voice signal with the computed frequency transposition function.

2. The method of processing voice signals according to claim 1, further comprising:
calculating a gain value of a total energy of the voice frame over the energy of the frequency transposed voice frame thereof; and
performing an energy compensation process on the frequency transposed voice frame according to the gain value.

3. The method of processing voice signals according to claim 1, wherein the step of estimating the effective bandwidth of the voice frame comprises:
calculating a ratio value of the total energy of the voice frame over an energy of a preset bandwidth of the voice frame; and
wherein when the ratio value is a preset value, the preset bandwidth is the effective bandwidth.

4. The method of processing voice signals according to claim 1, wherein the step of performing the frequency transposition process on the voice signal comprises:
generating a dynamic adjustment parameter according to a hearing bandwidth perceivable by human and an effective bandwidth of the voice frame; and
adjusting the frequency transposition function according to the dynamic adjustment parameter.

5. The method of processing voice signals according to claim 4, wherein the step of adjusting the frequency transposition function according to the dynamic adjustment parameter comprises:
performing a arc tangent function on a ratio value of the frequency prior to the frequency transposition processing over a constant; and
performing a tangent function on a ratio value of the result after the arc tangent function over the dynamic adjustment parameter to obtain the frequency after the frequency transposition processing.

6. The method of processing voice signals according to claim 1, wherein the step of converting one of the voice frames into the frequency domain is to perform a Fast Fourier Transform (FFT) process.

7. The method of processing voice signals according to claim 1, wherein the window function is a rectangular window function.

8. A method of processing voice signals, suitable for enhancing voice recognition ability of a person, comprising:
receiving a voice signal, wherein the voice signal is divided into a plurality of voice frames according to a window function;
judging whether one of the voice frames is a consonant featuring high-frequency voice;
converting one of the voice frame into the frequency domain and estimating an effective bandwidth of the voice frame, when the voice frame is judged as a consonant featuring high-frequency voice; and
computing a frequency transposition function according to an amount of the effective bandwidth and performing a frequency transposition process on the voice signal with the computed frequency transposition function.

9. The method of processing voice signals according to claim 8, wherein the step of judging whether one of the voice frames is the consonant featuring high-frequency voice further comprises:
calculating an energy in a lower band and an energy in a higher band of the voice frame; and
calculating the energy ratio value of the energy in the lower band to the energy in the higher band;
wherein when it is determined that the energy ratio value is less than a preset parameter value, the voice frame is judged as the consonant featuring high-frequency voice.

10. The method of processing voice signals according to claim 8, wherein after performing the frequency transposition process on the voice signal the method further comprises:
calculating a gain value of the total energy of the voice frame over the energy of the frequency transposed voice frame; and
performing an energy compensation process on the frequency transposed voice frame according to the gain value.

11. The method of processing voice signals according to claim 8, wherein the step of estimating the effective bandwidth of the voice frame comprises:
calculating a ratio value of the total energy of the voice frame over the energy of a preset bandwidth of the voice frame; and
when the ratio value is a preset value, the preset bandwidth is the effective bandwidth.

12. The method of processing voice signals according to claim 8, wherein the step of performing the frequency transposition process on the effective bandwidth comprises:
generating a dynamic adjustment parameter according to a hearing bandwidth perceivable by human and an effective bandwidth of the voice frame; and
adjusting the frequency transposition function according to the dynamic adjustment parameter.

13. The method of processing voice signals according to claim 12, wherein the step of adjusting the frequency transposition function according to the dynamic adjustment parameter comprises:
performing a arc tangent function on a ratio value of the frequency prior to the frequency transposition processing over a constant; and
performing a tangent function on a ratio value of the result after the arc tangent function over the dynamic adjustment parameter to obtain the frequency after the frequency transposition processing.

14. The method of processing voice signals according to claim 8, wherein the step of converting the voice frame into the frequency domain is to perform a Fast Fourier Transform (FFT) process.

15. The method of processing voice signals according to claim 8, wherein the window function is a rectangular window function.
